(19) United States
(12) Patent Application Publication
(10) Pub. No.: US 2023/0264347 A1
(43) Pub. Date: Aug. 24, 2023

(54) DRIVE DEVICE AND ROBOT

(71) Applicant: SEIKO EPSON CORPORATION, Tokyo (JP)

(72) Inventors: Akiko KABUKI, SUWA-GUN FUJIMI-MACHI (JP); Tomohisa IWAZAKI, SUWA-GUN SHIMOSUWA-MACHI (JP)

(21) Appl. No.: 18/111,908

(22) Filed: Feb. 21, 2023

(30) Foreign Application Priority Data
Feb. 22, 2022 (JP) 2022-025382

(51) Int. Cl. B25J 9/12

(52) U.S. Cl. CPC B25J 9/12

(57) ABSTRACT

A drive device includes a vibrator, and a rotor as a driven unit subjected to a drive force from the vibrator and relatively rotating or moving to the vibrator, wherein the rotor as the driven unit has a base portion and an elastic portion coupled to the base portion, and the base portion is located between the vibrator and the elastic portion.

The present application is based on, and claims priority from JP Application Serial Number 2022-025382, filed Feb. 22, 2022, the disclosure of which is hereby incorporated by reference herein in its entirety.

### BACKGROUND

### 1. Technical Field

The present disclosure relates to a drive device and a robot.

### 2. Related Art

In related art, there is an oscillating wave drive device that brings a vibrator and a driven member into pressure contact and relatively moves the vibrator to the driven member by vibration generated in the vibrator. For example, JP-A-2008-295234 discloses an oscillating wave drive device having a configuration in which an elastic member as a vibration absorber is provided in contact portions between the vibrator and the driven member to provide an elastic property and a damping function of absorbing vibration in order to avoid transient vibration and audible sound generated due to an unstable contact state of the vibrator contact portion and the driven member contact portion.

However, in the oscillating wave drive device disclosed in JP-A-2008-295234, the elastic member is provided between the vibrator and the driven member and there is a problem that pressure regulation for controlling a drive force is difficult.

### SUMMARY

A drive device includes a vibrator, and a driven unit subjected to a drive force from the vibrator and relatively rotating or moving to the vibrator, wherein the driven unit has a base portion and an elastic portion coupled to the base portion, and the base portion is located between the vibrator and the elastic portion.

A robot includes the above described drive device, an arm portion, and a drive unit driving the arm portion, wherein the drive device is provided in the drive unit.

### BRIEF DESCRIPTION OF THE DRAWINGS

FIG. 1 is a plan view of a drive device according to a first embodiment.

FIG. 2 is a sectional view along line A-A in FIG. 1.

FIG. 3 is a perspective view showing a schematic structure of a piezoelectric motor.

FIG. 4 is a plan view showing a schematic structure of a vibrator.

FIG. 5 is a sectional view of a drive device according to a second embodiment.

FIG. 6 is a sectional view of a drive device according to a third embodiment.

FIG. 7 is a plan view of a drive device according to a fourth embodiment.

FIG. 8 is a sectional view along line B-B in FIG. 7.

FIG. 9 is a schematic diagram of a robot according to a fifth embodiment.

### DESCRIPTION OF EXEMPLARY EMBODIMENTS

### 1. First Embodiment

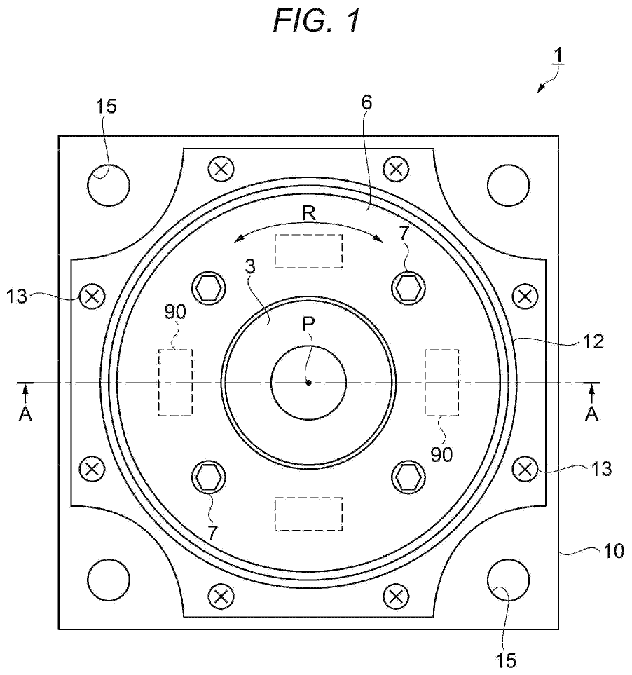

First, a drive device 1 according to a first embodiment will be explained with reference to FIGS. 1 to 4.

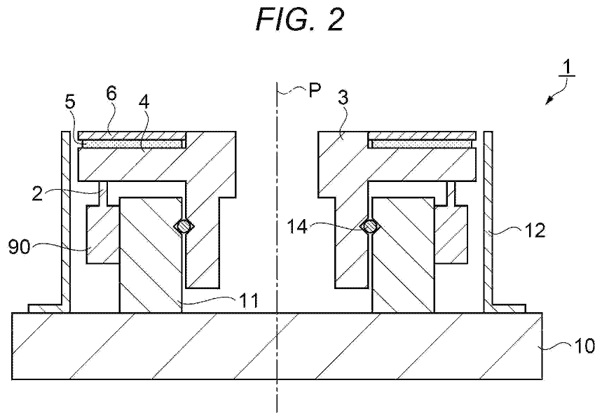

As shown in FIGS. 1 and 2, the drive device 1 includes piezoelectric motors 90 having vibrators 2, a rotor 3 as a driven unit subjected to a drive force from the vibrators 2 and relatively rotating, a base 10 supporting the rotor 3 and fixing the piezoelectric motors 90, and a cover 12 protecting the piezoelectric motors 90 and the rotor 3.

The rotor 3 is a doughnut-shaped circular disk having a hollow cavity at the center, rotates in directions of an arrow R around a rotation axis P, and is supported by a fixing portion 11 provided in the base 10 via a bearing 14. Further, the rotor 3 has a base portion 4 located in the outer peripheral part of the rotor 3, an elastic portion 5 coupled to the base portion 4, and a weight portion 6 coupled to the elastic portion 5. Note that, as the material of the base portion 4 of the rotor 3, carbon, cast iron, or the like having higher rigidity than the rigidity of the elastic portion 5 is used.

The base portion 4 is located between the vibrator 2 of the piezoelectric motor 90 and the elastic portion 5 and the weight portion 6 is placed at the opposite side to the base portion 4 with respect to the elastic portion 5. Further, the vibrator 2 and the elastic portion 5 overlap in a plan view in a direction in which the vibrator 2 and the base portion 4 are arranged, and the direction in which the vibrator 2 and the base portion 4 are arranged is along the rotation axis P. The elastic portion 5 and the weight portion 6 are fixed to the base portion 4 of the rotor 3 by bolts 7. Note that the fixation of the elastic portion 5 and the weight portion 6 is not limited to that, but the portions may be fixed by an adhesive or the like.

As the material of the elastic portion 5, low-resilience urethane rubber is used in a preferable example. Note that the material is not limited to that as long as the material is an elastic member. For example, elastomer, rubber, and foamed members thereof may be used.

As the material of the weight portion 6, brass is used in a preferable example. Note that the material is not limited to that as long as the material has a large specific gravity. For example, metals including gold, tungsten, lead, copper, and iron and alloys thereof may be used.

It is only necessary that the materials of the elastic portion 5 and the weight portion 6 are materials having properties that can function as dynamic vibration absorbers. For example, it is preferable that the Young's modulus of the weight portion 6 is higher than the Young's modulus of the elastic portion 5.

Note that, in the embodiment, the elastic portion 5 and the weight portion 6 are provided as the dynamic vibration absorbers, however, only the elastic portion 5 may be provided.

The base 10 has the fixing portion 11 on a surface of the base 10 facing the rotor 3 and supports the rotor 3 via the bearing 14 in the fixing portion 11. Further, in the fixing portion 11, the piezoelectric motors 90 are fixed to the opposite side to a rotor 3 side.

The cover 12 protecting the piezoelectric motors 90 and the rotor 3 is attached onto the base 10 by screws 13.

Further, in the base 10, attachment holes 15 for attachment of the drive device 1 to another device or the like are provided in the outer peripheral part of the cover 12.

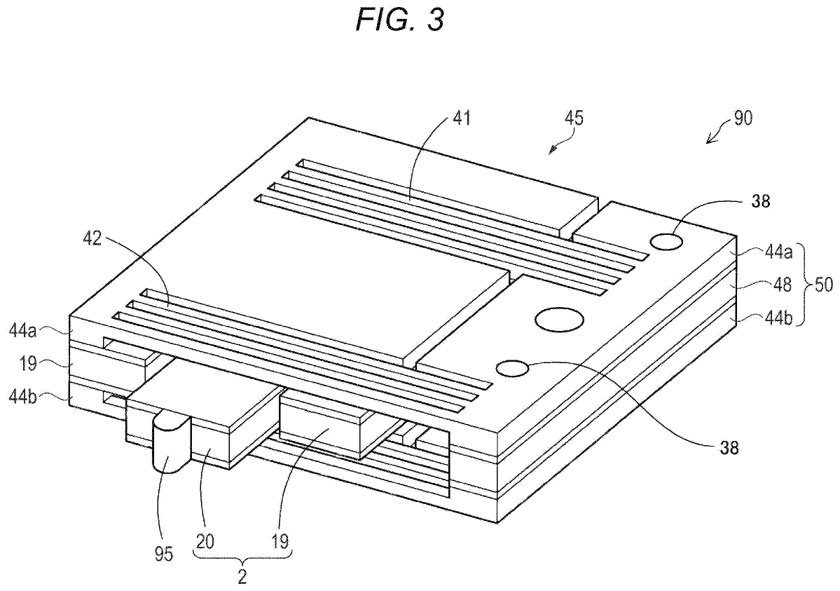

As shown in FIG. 3, the piezoelectric motor 90 includes the vibrator 2, an urging portion 45, a fixing portion 50, etc.

The vibrator 2 includes a vibrator element 20 having a piezoelectric material as a vibration source, a holding portion 19 holding the vibrator element 20, etc. The vibrator element 20 has a rectangular shape. Note that the details of the vibrator 2 will be described later.

The urging portion 45 includes a pair of parallel springs 44a, 44b placed on the upside and the downside of the vibrator 2.

One end of the parallel spring 44a is integrated as the fixing portion 50 and the other end of the parallel spring 44a is coupled to the holding portion 19 of the vibrator 2.

In the parallel spring 44a, flat springs 41, 42 extending in the short-side directions of the vibrator element 20 are provided and urge the vibrator 2 in a direction in which a projecting portion 95 is pressed against the base portion 4 of the rotor 3. The flat spring 41 includes a plurality of flat springs provided at the back end side of the vibrator element 20 and the flat spring 42 includes a plurality of flat springs provided at the front end side of the vibrator element 20. The parallel spring 44b provided on the rear surface of the vibrator 2 has the same configuration.

The parallel springs 44a, 44b are provided to sandwich the vibrator 2 from upside and downside and configured to urge the vibrator 2 in the long-side direction of the vibrator element 20. In other words, the urging portion 45 couples the holding portion 19 including the vibrator element 20 urged in the direction of the projecting portion 95 to the fixing portion 50.

The fixing portion 50 includes a base member 48, the parallel springs 44a, 44b, etc. The fixing portion 50 is integrated with the parallel spring 44a and the parallel springs 44b superimposed on the upside and the downside of the base member 48 as a base. Further, the fixing portion is fixed to the fixing portion 11 of the base 10 in two screw holes 38 by screws. The opposite end in the vibrator 2 to the fixing portion 50 is integrated with the parallel spring 44a and the parallel springs 44b superimposed on the upside and the downside of the holding portion 19.

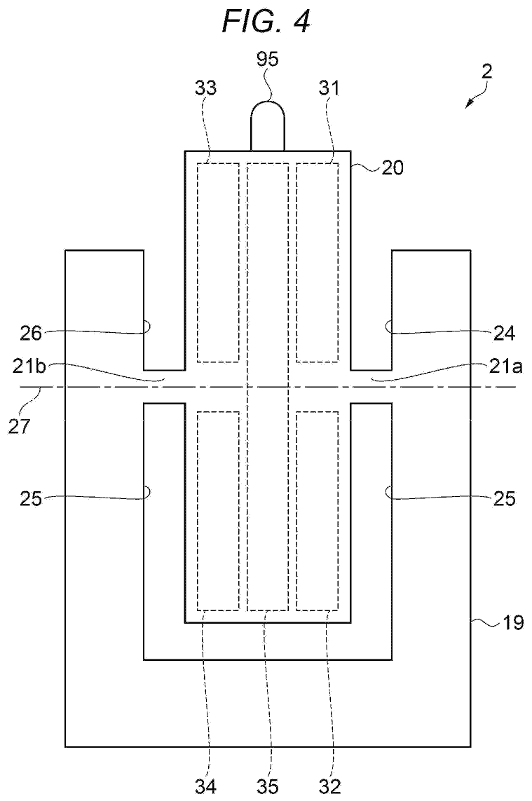

As shown in FIG. 4, the vibrator 2 has the holding portion 19, the vibrator element 20, and the projecting portion 95. The holding portion 19 has a rectangular shape and a silicon substrate is used therefor as a preferable example. Note that, in a preferable example, silicon substrates are used for the urging portion 45 and the fixing portion 50, however, the portions are not limited to those. Any material having an equal property e.g., a metal may be used.

The vibrator element 20 is a part sectioned in a rectangular shape within the holding portion 19 and drive piezoelectric elements 31 to 35 are placed on the back surface side. Specifically, the vibrator element 20 is sectioned substantially in the rectangular shape by three cutout parts 24, 25, 26 provided in the holding portion 19 substantially in the rectangular shape. Further, the vibrator element is coupled to the holding portion 19 by a pair of supporting arms 21a, 21b left substantially at the center of the long sides of the rectangular shape. A line segment passing through the supporting arms 21a, 21b and extending in the short-side directions is referred to as “center line 27”.

The rectangular piezoelectric elements 31, 32 are placed along one long side of the vibrator element 20. The piezoelectric element 31 and the piezoelectric element 32 are placed line-symmetrically with respect to the center line 27.

Similarly, the rectangular piezoelectric elements 33, 34 are placed along the other long side of the vibrator element 20. The piezoelectric element 33 and the piezoelectric element 34 are, placed line-symmetrically with respect to the center line 27.

Further, at the center of the vibrator element 20, the rectangular piezoelectric element 35 having the length of the connected piezoelectric element 31 and piezoelectric element 32 is provided.

Though not shown in FIG. 4, electrodes and wires for supplying drive signals to the piezoelectric elements are provided on the back surfaces of the piezoelectric elements 31 to 35. The electrically same wires are coupled to the piezoelectric element 31 and the piezoelectric element 34 diagonally located in the vibrator element 20. Similarly, the electrically same wires are coupled to the piezoelectric element 32 and the piezoelectric element 33. The different wire from the above described wires is coupled to the piezoelectric element 35. Note that a common wire is provided on the under layer side of the piezoelectric elements 31 to 35. The common wire is coupled to the ground potential in a preferable example.

Alternating-current drive signals supplied to the piezoelectric elements 31, 34 are first drive signals. Second drive signals different by 180 degrees in phase from the first drive signals are supplied to the piezoelectric elements 32, 33. Further, a third drive signal different in phase from the first drive signals or the second drive signals is supplied to the piezoelectric element 35. For example, as the third drive signal, a signal different by 90 degrees in phase from the first drive signals is supplied.

The above described drive signals are respectively supplied to the piezoelectric elements 31 to 35, and thereby, the vibrator element 20 stretchingly vibrates in the long-side directions and flexurally vibrates in the short-side directions. In other words, the piezoelectric elements 31 to 35 in-plane vibrate in a plane of the substrate. These vibrations are synthesized, and thereby, for example, the tip end of the projecting portion 95 makes an elliptical motion to draw an elliptical trajectory clockwise or counterclockwise. The rotor 3 is moved out by the elliptical motion of the projecting portion 95, and the rotor 3 rotates clockwise or counterclockwise in the directions of the arrow R.

When the piezoelectric motor 90 having the above described basic configuration is driven, there is a problem that the holding portion 19 holding the vibrator element 20 also vibrates with the vibration of the vibrator element 20. Specifically, in FIG. 4, when the vibrator element 20 is vibrationally driven within the plane containing the long-side directions and the short-side directions, the holding portion 19 also vibrates within the same plane via the supporting arms 21a, 21b. The vibration is unnecessary vibration not contributing to the drive force and reduces the drive output. Further, the unnecessary vibration is transmitted to the base portion 4 of the rotor 3 via the projecting portion 95 and the rotor 3 also vibrates and hinders the stable rotational motion. Accordingly, in the drive device 1 of the embodiment, the elastic portion 5 and the weight portion 6 functioning as dynamic vibration absorbers are placed at the opposite side to a vibrator 2 side of the base portion 4 of the rotor 3 and unnecessary vibration from the vibrator 2 is suppressed.

As described above, in the drive device 1 of the embodiment, the elastic portion 5 is fixed to the opposite side to the side in contact with the vibrator 2 in the base portion 4 of the rotor 3 that is subjected to the drive force from the vibrator 2 and relatively rotates. That is, the base portion 4 of the rotor 3 is located between the vibrator 2 and the elastic portion 5, and thereby, the elastic portion 5 functions as the dynamic vibration absorber and the unnecessary vibration from the vibrator 2 to the rotor 3 may be suppressed. Therefore, the rotor 3 may be stably rotationally moved.

Further, rigidity may be secured between the vibrator 2 and the base portion 4 and the pressure regulation for controlling the drive force is easier.

### 2. Second Embodiment

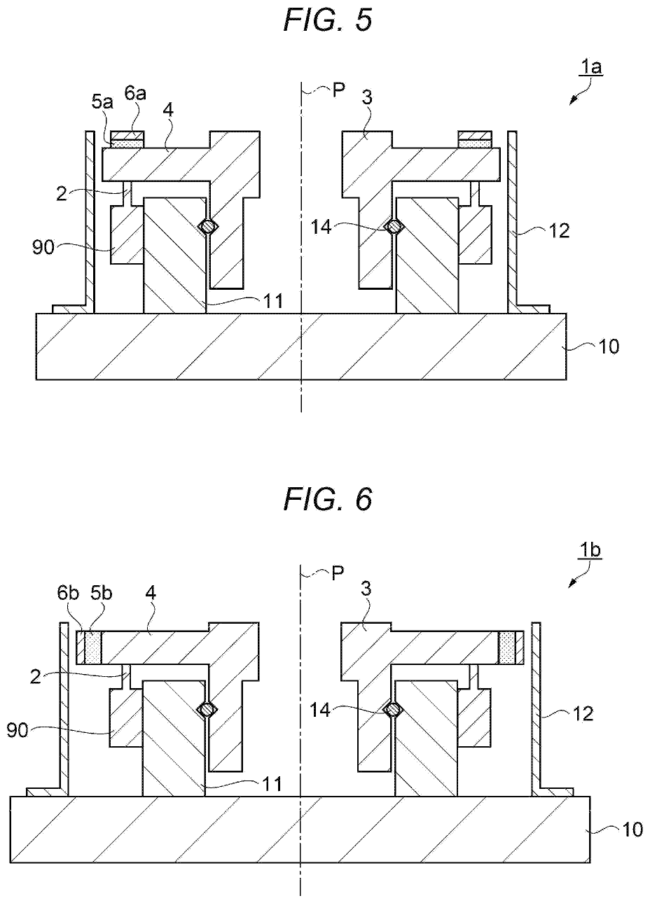

Next, a drive device 1a according to a second embodiment will be explained with reference to FIG. 5.

The drive device 1a of the embodiment is the same as the drive device 1 of the first embodiment except that shapes of an elastic portion 5a and a weight portion 6a provided on the base portion 4 are different from those of the drive device 1 of the first embodiment. The embodiment will be explained with a focus on differences from the above described first embodiment and the explanation of the same items will be omitted. Further, in FIG. 5, the same configurations as those of the above described embodiment have the same signs.

As shown in FIG. 5, in the drive device 1a of the embodiment, the elastic portion 5a and the weight portion 6a are placed only in positions overlapping with the vibrator 2 in the plan view in the direction in which the vibrator 2 and the base portion 4 are arranged on the base portion 4 of the rotor 3. That is, the elastic portion 5a and the weight portion 6a are not placed in positions overlapping with the fixing portion 11 on the base portion 4 in the plan view in the direction in which the vibrator 2 and the base portion 4 are arranged.

According to the configuration, the effects equal to those of the above described first embodiment may be obtained.

### 3. Third Embodiment

Next, a drive device 1b according to a third embodiment will be explained with reference to FIG. 6.

The drive device 1b of the embodiment is the same as the drive device 1 of the first embodiment except that positions where an elastic portion 5b and a weight portion 6b are placed on the base portion 4 are different from those of the drive device 1 of the first embodiment. The embodiment will be explained with a focus on differences from the above described first embodiment and the explanation of the same items will be omitted. Further, in FIG. 6, the same configurations as those of the above described embodiment have the same signs.

As shown in FIG. 6, in the drive device 1b of the embodiment, the elastic portion 5b and the weight portion 6b are placed on a side surface of the rotor 3 in a direction crossing the direction in which the vibrator 2 and the base portion 4 are arranged. That is, the elastic portion 5b and the weight portion 6b are placed on a side surface of the base portion 4 in the order of the elastic portion 5b and the weight portion 6b and fixed by an adhesive or the like.

According to the configuration, the effects equal to those of the above described first embodiment may be obtained.

### 4. Fourth Embodiment

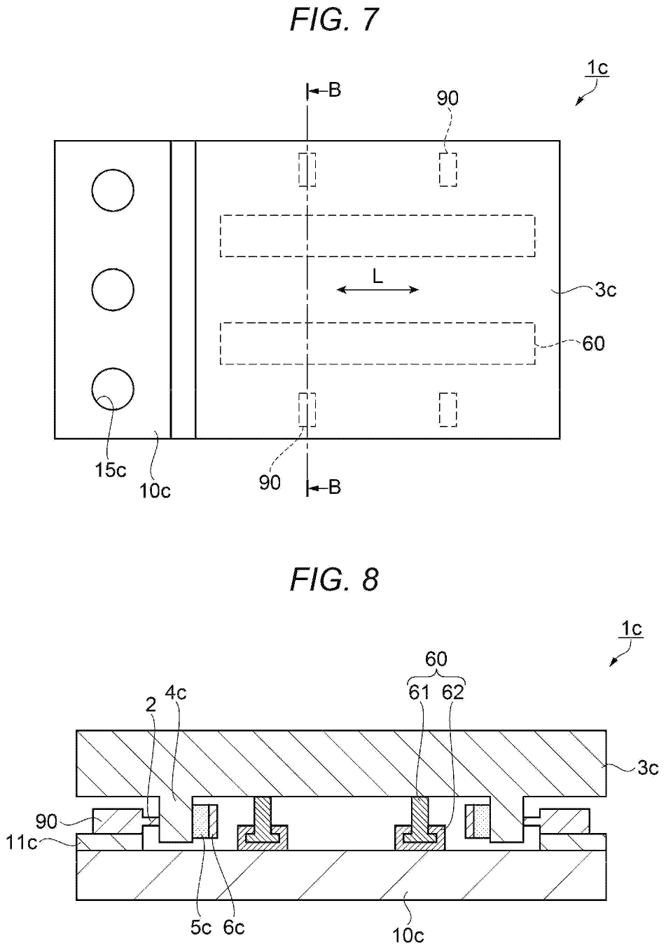

Next, a drive device 1c according to a fourth embodiment will be explained with reference to FIGS. 7 and 8.

The drive device 1c of the embodiment is the same as the drive device 1 of the first embodiment except that a movement direction of a stage 3c as a driven unit is different from that of the drive device 1 of the first embodiment. The embodiment will be explained with a focus on differences from the above described first embodiment and the explanation of the same items will be omitted. Further, in FIGS. 7 and 8, the same configurations as those of the above described embodiment have the same signs.

As shown in FIGS. 7 and 8, the drive device 1c of the embodiment includes the piezoelectric motors 90 having the vibrators 2, the stage 3c subjected to a drive force from the vibrator 2 and relatively moving, and a base 10c supporting the stage 3c via guiding portions 60 and fixing the piezoelectric motors 90.

The stage 3c has a rectangular shape and moves in directions of an arrow L by the guiding portions 60 guiding in linear directions. Further, on a surface of the stage 3c facing the base 10c, a base portion 4c in contact with the vibrator 2 and rails 61 forming the guiding portions 60 are provided.

The base portion 4c is located between the vibrator 2 of the piezoelectric motor 90 and an elastic portion 5c, and a weight portion 6c is placed at the opposite side to the base portion 4c with respect to the elastic portion 5c. Further, the vibrator 2 and the elastic portion 5c overlap in a plan view in a direction in which the vibrator 2 and the base portion 4c are arranged. Note that the base portion 4c and the elastic portion 5c are fixed by an adhesive or the like and the elastic portion 5c and the weight portion 6c are fixed by an adhesive or the like.

On the base 10c, a fixing portion 11c fixing the piezoelectric motors 90 so that the vibrator 2 and the base portion 4c may face each other and guides 62 forming the guiding portion 60 guiding the stage 3c in the linear directions are provided.

Further, in the base 10c, attachment holes 15c for attachment of the drive device 1c to another device or the like are provided in positions not overlapping with the stage 3c in the plan view.

According to the configuration, the effects equal to those of the above described first embodiment may be obtained.

### 5. Fifth Embodiment

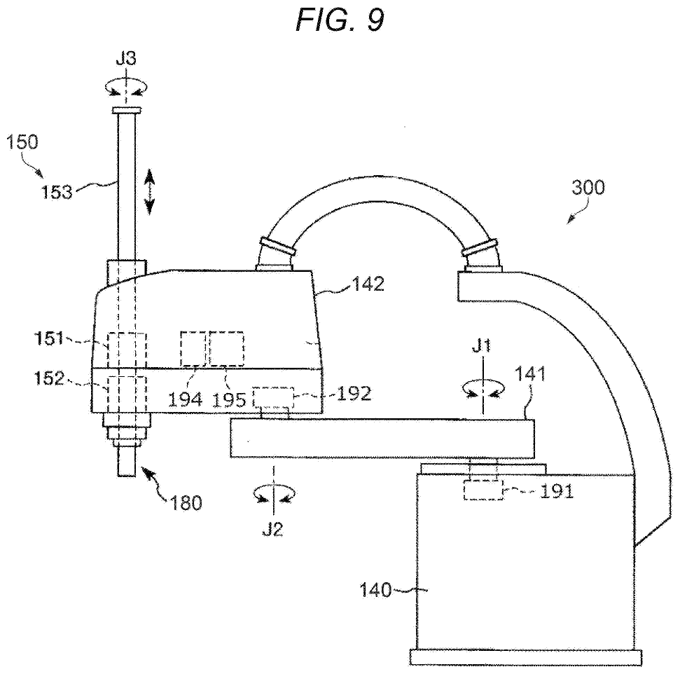

Next, a robot 300 according to a fifth embodiment will be explained with reference to FIG. 9.

The robot 300 of the embodiment is a horizontal articulated robot including a plurality of arms, also known as a scalar robot.

The robot 300 includes a base 140, a first arm 141, a second arm 142, a working head 150, etc.

The base 140 is a pedestal of the robot 300 and, for example, fixed to a floor surface by bolts or the like. Note that the installation location of the base 140 is not limited to the floor, but may be e.g., a wall, a ceiling, a movable platform, or the like.

The first arm 141 is pivotably coupled to the base 140 via a joint portion.

The second arm 142 is pivotably coupled to the first arm 141 via a joint portion. The working head 150 is provided at the distal end side of the second arm 142.

Inside of the base 140, a drive unit 191 pivoting the first arm 141 relative to the base 140 around an axis J1 is placed. The drive unit 191 includes a drive motor as a drive source driving the first arm 141. Further, a joint mechanism including a gear and a rotation shaft is incorporated into the joint portion (not shown).

Inside of the second arm 142, a drive unit 192 pivoting the second arm 142 relative to the first arm 141 around an axis J2 is placed. The configuration of the drive unit 192 and the accompanying joint portion is the same as the configuration of the drive unit 191. Note that driving of the drive units 191, 192, 194, 195 is controlled by a robot control unit (not shown) including one or more processors.

The working head 150 is provided in the distal end portion of the second arm 142, and includes a spline nut 151, a ball screw nut 152, a spline shaft 153, etc.

The spline shaft 153 having a rod shape is axially inserted through the spline nut 151 and the ball screw nut 152.

The spline shaft 153 is rotatable around an axis J3 thereof and elevatable in upward and downward directions. Specifically, the rotational and elevational driving is performed by the drive unit 194 and the drive unit 195 provided inside of the second arm 142. When the spline nut 151 is rotationally driven by the drive unit 194, the spline shaft 153 rotates around the axis J3 with the rotation. When the ball screw nut 152 is rotationally driven by the drive unit 195, the spline shaft 153 moves in the upward and downward directions with the rotation.

Further, a hand 180 as an end effector is attached to the distal end portion or the lower end portion of the spline shaft 153.

Here, the rotationally driving drive devices 1, 1a, 1b of the above described embodiment are used for the drive unit 191 of the first arm 141 as a drive source. Similarly, the drive devices 1, 1a, 1b is used for the drive units 192, 194, 195 as a drive motor. In other words, the robot 300 includes the first arm 141 and the second arm 142 as the plurality of arm portions and the drive units 191, 192 driving the plurality of arm portions, and the drive devices 1, 1a, 1b are provided in the drive units 191, 192.

According to the configuration, the drive devices 1, 1a, 1b reducing unnecessary vibration and stably rotationally moving are used as the drive source, and the robot 300 that can perform higher efficient work with lower power consumption may be provided.

When the hand 180 includes fingers for work or the like, the drive devices 1, 1a, 1b of the embodiment may be used as drive units for the fingers.

Here, the explanation is made using the horizontal articulated robot, however, the robot may be any robot having an arm, e.g., a vertical articulated robot such as a six-axis vertical articulated robot. According to the configuration, the same effects as the effects in the above described respective embodiments may be obtained.

What is claimed is:

1. A drive device comprising:
a vibrator; and
a driven unit subjected to a drive force from the vibrator and relatively rotating or moving to the vibrator, wherein
the driven unit has a base portion and an elastic portion coupled to the base portion, and
the base portion is located between the vibrator and the elastic portion.

2. The drive device according to claim 1, further comprising a weight portion, wherein
the weight portion is placed at an opposite side to the base portion with respect to the elastic portion.

3. The drive device according to claim 2, wherein
a Young's modulus of the weight portion is higher than a Young's modulus of the elastic portion.

4. The drive device according to claim 2, wherein
the elastic portion and the weight portion are fixed by a bolt.

5. The drive device according to claim 1, wherein
the vibrator and the elastic portion overlap in a plan view in a direction in which the vibrator and the base portion are arranged.

6. The drive device according to claim 1, wherein
the driven unit is a rotor rotating around a rotation axis, and
a direction in which the vibrator and the base portion are arranged is along the rotation axis.

7. The drive device according to claim 1, wherein
the driven unit is a rotor rotating around a rotation axis, and
the elastic portion is placed on a side surface of the rotor.

8. The drive device according to claim 1, further comprising a guiding portion guiding the driven unit in linear directions.

9. A robot comprising:
the drive device according to claim 1;
an arm portion; and
a drive unit driving the arm portion, wherein
the drive device is provided in the drive unit.
